(19) United States
(12) Patent Application Publication
(10) Pub. No.: US 2019/0349246 A1
(43) Pub. Date: Nov. 14, 2019

(54) METHOD AND SYSTEM FOR MANAGING A PLURALITY OF SERVER UNITS

(71) Applicant: American Megatrends Inc., Norcross, GA (US)

(72) Inventor: Chi-Tsai Chang, Taipei (TW)

(73) Assignee: American Megatrends Inc., Norcross, GA (US)

(21) Appl. No.: 15/978,843

(22) Filed: May 14, 2018

(51) Int. Cl. H04L 12/24; H04L 29/06; H04L 12/26

(52) U.S. Cl. CPC H04L 41/0672; H04L 43/04; H04L 69/18

(57) ABSTRACT

A method and system for managing a plurality of server units are provided. Each server unit has a computing device and a baseboard management controller (BMC) connected thereto. A control unit interfaces with each of the computing devices through a first protocol, and interfaces with each of the BMCs through a second protocol different from the first protocol. The method includes: (a) sending a command through the second protocol via the control unit to each BMC to obtain the server information thereof; (b) determining, using the control unit, whether the server information of each computing device stored in the control unit corresponds to the server information obtained from one of the BMCs; and (c) mapping one of the computing devices to one of the BMCs when the server information of said computing device corresponds to the server information obtained from said BMC.

### FIELD OF THE INVENTION

The present invention relates to a management method and system, and more particularly to a method and system for managing a plurality of server units.

### BACKGROUND

Computing devices normally operate within a range of parameters, with the operation performance being monitored by sensors. The parameters being monitored may include the temperature and humidity within a computer case, voltages of semiconductor components, the velocity of cooling fans, etc. A management method is often used to collect and analysis monitor data reported from sensors measuring the operation and performance of the computing device. Furthermore, the management method enables the performance of administrative tasks on the computing device such that certain corrective action can be taken when the parameters stray beyond specified limits.

One such management method has been realized using Intelligent Platform Management Interface (IPMI), which is a set of computer interface specifications for a network of computing devices. An IPMI includes mainly a baseboard management controller (BMC) and other controller components. The BMC is a specialized microcontroller embedded on the motherboard of a computer and independent of the operating system thereof. Although typically configured in the baseboard of the computing device so as to monitor the physical state thereof, the BMC communicates with the control unit of remote manager system through a different protocol than the computing system does with the control unit. Furthermore, since the BMC and the computing system operate independently, they use different LAN ports. This means the information that the BMC transmits to the remote manager platform and that transmitted by the computing device are also independent. Therefore, problems arise when a remote manager system manage multiple computing devices using multiple BMCs, wherein the remote manager system fails to recognize a BMC and a computing device being on the same server. For instance, when one of the computing devices goes through a power failure, complex mutual communication between the BMCs and the computing devices has to be performed before the remote manager system can determine which BMC is to be controlled to reboot the failed computing device.

### SUMMARY

Accordingly, one of the objectives of the present invention is to provide a method and system for managing a plurality of server units, which enable a remote management platform to recognize a BMC and a computing device being on the same server.

In order to achieve the aforementioned objective, one embodiment of the present invention provides a method for managing a plurality of server units. Each server unit has a computing device and a baseboard management controller (BMC) connected thereto. The control unit interfaces with each of the computing devices through a first protocol, and interfaces with each of the BMCs through a second protocol different from the first protocol. The BMC and the computing device that are on the same server unit each have a server information corresponding to each other. The method includes: (a) sending a command through the second protocol via the control unit to each BMC to obtain the server information thereof; (b) determining, using the control unit, whether the server information of each computing device stored in the control unit corresponds to the server information obtained from one of the BMCs; and (c) mapping one of the computing devices to one of the BMCs when the server information of said computing device corresponds to the server information obtained from said BMC.

Another embodiment of the present invention provides a system for managing a plurality of server units including a plurality of server units and a control unit. The plurality of server units each includes a computing device and a baseboard management controller (BMC) connected thereto. The BMC and the computing device that are on the same server unit each have a server information corresponding to each other. The control unit interfaces with each of the computing devices through a first protocol and interfaces with each of the BMCs through a second protocol different from the first protocol. The control unit is configured to send a command through the second protocol to each BMC to obtain the server information thereof, determine whether the server information of each computing device stored in the control unit corresponds to the server information obtained from one of the BMCs, and map one of the computing devices to one of the BMCs when the server information of said computing device corresponds to that of said BMC.

In order to further the understanding of the present disclosure, reference is made to the following detailed description illustrating the embodiments and examples of the present disclosure. The description is for illustrative purpose only and is not intended to limit the scope of the claim.

### BRIEF DESCRIPTION OF THE DRAWINGS

FIG. 1 is a functional block diagram illustrating a system for managing a plurality of server units according to one embodiment of the present invention.

FIG. 2 is a schematic view illustrating the system for managing a plurality of server units according to one embodiment of the present invention.

FIG. 3 is a flow chart illustrating a method for managing a plurality of server units according to one embodiment of the present invention.

FIG. 4 is a flow chart illustrating a method for managing a plurality of server units according to another embodiment of the present invention.

### DETAILED DESCRIPTION OF EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

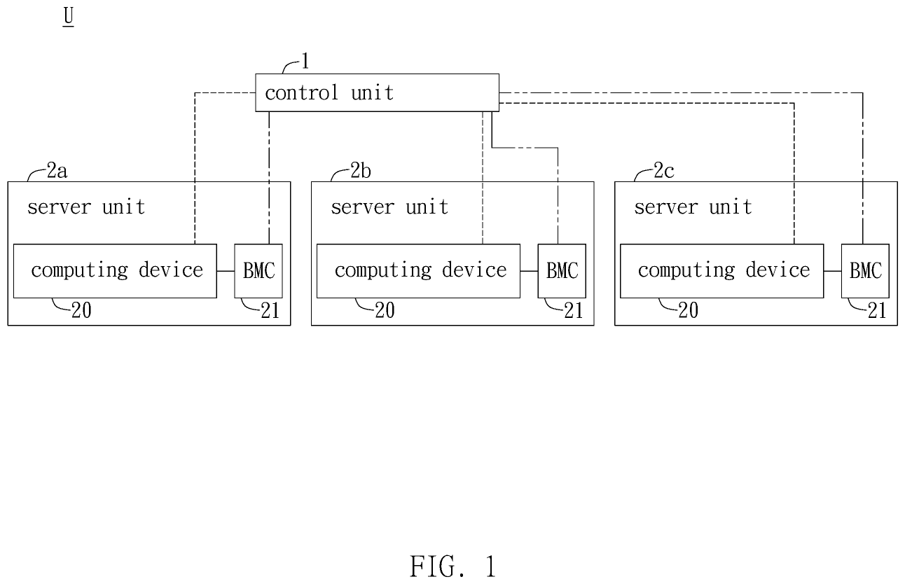

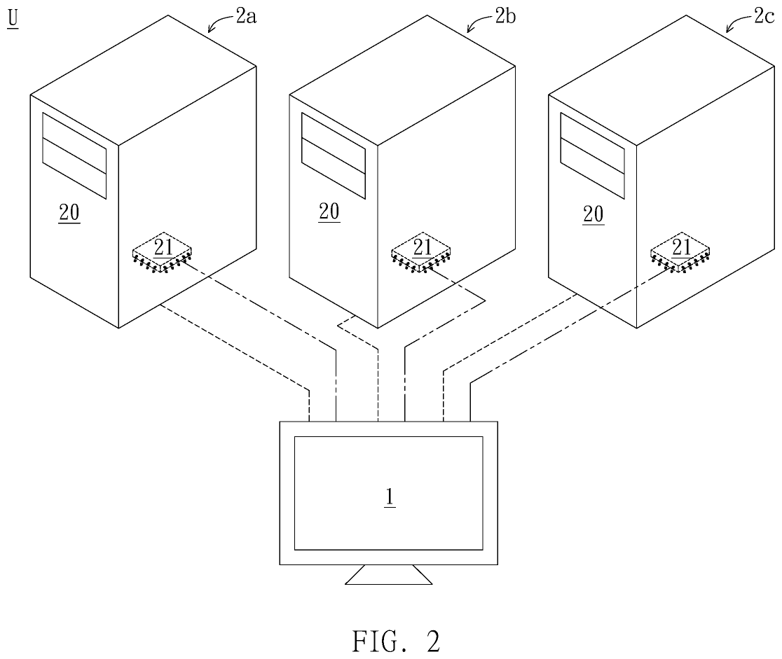

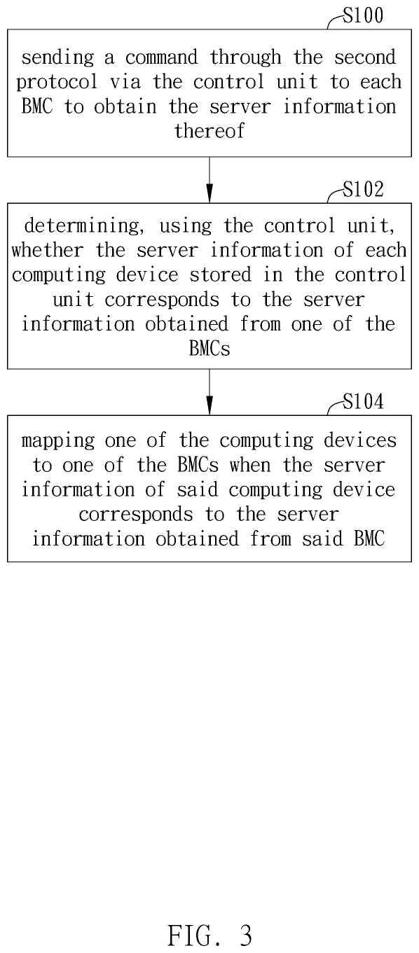

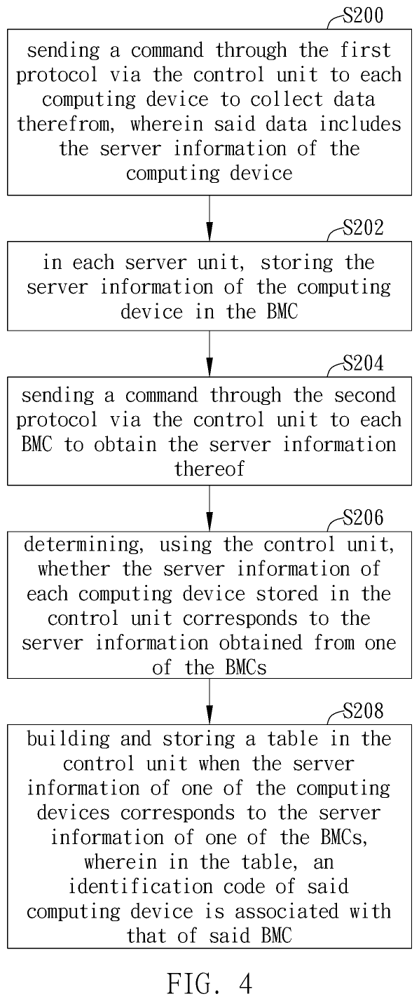

Referring to FIG. 1 and FIG. 2, which show a functional block diagram and a schematic diagram of a system U for managing a plurality of server units (2a, 2b, 2c) provided by the present invention. In the following description, the system U will first be described below with reference to FIG. 1 and FIG. 2, and the method of using the system U will be described afterwards with reference to FIG. 3 and FIG. 4.

As shown in FIG. 1, the system U includes a control unit 1 and a plurality of server units (2a, 2b, 2c). Each server unit (2a, 2b, 2c) has a computing device 20 and a baseboard management controller (BMC) 21 connected thereto. In the present embodiment, the number of server units is three; however, the present invention is not limited thereto.

With reference to FIG. 1, the server units (2a, 2b, 2c) are in signal connection with a control unit 1. More specifically, the control unit 1 interfaces with each of the computing devices 20 through a first protocol, each depicted with a dashed line in FIG. 1 and FIG. 2. Furthermore, the control unit 1 interfaces with each of the BMCs 21 through a second protocol that is different from the first protocol, each depicted with a two-dot chain line in FIG. 1 and FIG. 2.

The present invention does not limit the first protocol and the second protocol to a specific type. For instance, when the plurality of computing devices 20 run under Windows operating system, the control unit 1 can interface with the computing devices 20 through standard WMI interfaces, and when the plurality of computing devices 20 run under Linux operating system, the control unit 1 can interface with the computing devices 20 through standard SSH interfaces. Moreover, in the present embodiment, the second protocol is the IPMI interface.

Moreover, with reference to FIG. 2, each computing device 20 can be exemplified as a server, and the control unit 1 can be implemented as a server computer programmed to perform the method of the present invention that will be described below. As shown in FIG. 2, each of the BMCs 21 is disposed inside the computing device 20, and more specifically, embedded on the baseboard (or motherboard) of the computing device. It should be noted that the present invention is not limited to the above-described.

In the present embodiment, the BMC 21 and the computing device 20 that are on the same server unit (2a, 2b, 2c) have a server information corresponding to each other. To be specific, in the present embodiment, the server information can be a MAC address of said server unit 2. Furthermore, in the present embodiment, the server information of the BMC is the MAC address of the computing device 20 that is stored in the BMC prior to the performance of step S100. Therefore, “corresponding to each other” mentioned above means, for a computing device 20 and a BMC that are on the same server unit, the server information of the computing device 20 and the server information of the BMC 21 are the same. For instance, referring to FIG. 2, the computing device 20 and the BMC 21 of the server unit 2a will have the same server information, which, in this embodiment, is the MAC address of the computing device 20. However, the present invention is not limited thereto. In other embodiment, the server information can be other information about a server unit that make the computing device 20 and the BMC 21 belonging to that server unit distinguishable from other computing device 20 and BMC 21 on other server units, and “corresponding to each other” can refer to, for example, similarity in the numerical aspect.

As mentioned in the background section, a BMC is typically embedded on the baseboard of a computing device. Since the server information is one that the computing device 20 and the BMC 21 on the same server unit share, in other embodiments, the server information can also be the serial number of the baseboard of the computing devices 20. Alternatively, in yet another embodiment, the server information of the BMC 21 can be the UUID of the computing device 20 that is on the same server unit as the BMC 21.

With reference to FIG. 3, the present invention further provides a method for managing a plurality of server unit 2 using the system U. The method includes a step S100 of sending a command through the second protocol via the control unit 1 to each BMC 21 to obtain the server information thereof; a step S102 of determining, using the control unit 1, whether the server information of each computing device 20 stored in the control unit 1 corresponds to the server information obtained from one of the BMCs 21; and a step S104 of mapping one of the computing devices 20 to one of the BMCs 21 when the server information of said computing device 20 corresponds to the server information obtained from said BMC 21.

Specifically, in this embodiment, the control unit 1 sends an IPMI OEM command to each BMC 21 to obtain the server information thereof. In step S102, the control unit 1 compares the server information of each computing device 20 stored therein with the retrieved server information of each BMC 21. Upon finding server information existing in one of the computing devices 20 and one of the BMCs 21 at the same time, the control unit 1 maps said computing device 20 to said BMC 21. The control unit 1 will keep doing so until it has checked the server information of all the computing devices 20 stored therein.

The way of mapping said computing device 20 and to said BMC 21 can be, but not limited to adding a tag indicating the association of said computing device 20 with said BMC 21. In other words, by mapping one computing device 20 to one BMC 21 that share the same server information, the method of the present invention enables the control unit 1 to recognize that said computing device 20 and said BMC 21 are on the same server unit 2a, 2b or 2c.

With reference to FIG. 4, in another embodiment of the present invention, the method for managing a plurality of server units (2a, 2b, 2c) includes a step S200: sending a command through the first protocol via the control unit 1 to each computing device 20 to collect data therefrom, wherein said data includes the server information of the computing device 20; and a step S202: in each server unit (2a, 2b, 2c), storing the server information of the computing device 20 in the BMC 21.

More specifically, where the control unit 1 has not yet built management relationship with the computing devices 20, or where the control unit 1 does not possess information that can help recognize the BMC 21 on the same server unit as another computing device 20, the control unit 1 performs step 200 and step 202. Moreover, in step S202, the control unit 1 stores the server information of the computing device 20 of the server unit 2a in the BMC 21 of the server unit 2a, and does the same for the server unit 2b and the server unit 2c.

Afterwards, referring to FIG. 4, the method further includes a step S204: sending a command through the second protocol via the control unit 1 to each BMC 21 to obtain the server information thereof; a step S206: determining, using the control unit 1, whether the server information of each computing device 20 stored in the control unit 1 corresponds to the server information obtained from one of the BMCs 21; and a step S208: building and storing a table in the control unit 1, wherein in the table, an identification code of said computing device 20 is associated with that of said BMC 21.

In this embodiment, the aforementioned step S104 of mapping one of the computing devices 20 to one of the BMCs 21 when the server information of said computing device 20 corresponds to that obtained from said BMC 21 is alternatively realized by step S208.

Specifically, the table built in step S208 is exemplarily shown as Table 1 below. It should be noted that, Table 1 is for illustration purpose only, and should not be deemed as a limitation to the present embodiment.

TABLE 1

| | Computing device | Computing device | Computing device |
|---|---|---|---|
| | 1001 | 1002 | 1003 |
| BMC 2001 | | Server unit 2b | |
| BMC 2002 | Server unit 2a | | |
| BMC 2003 | | | Server unit 2c |

In Table 1, the computing devices 20 shown in FIG. 2 are respectively assigned an identification code 1001, 1002, and 1003, and the BMCs 21 shown in FIG. 2 are respectively assigned an identification code 2001, 2002, and 2003. In step S206, the control unit 1 determines that the computing device 20 having the identification code 1001 has the same MAC address as that of the BMC with the identification code 2002, the computing device 20 having the identification code 1002 has the same MAC address as that of the BMC with the identification code 2001, and the computing device 20 having the identification code 1003 has the same MAC address as that of the BMC with the identification code 2003. In step S208, the control unit 1 then builds table 1 indicating that the computing device 20 with the identification code 1001 and the BMC 21 with the identification code 2002 are on the same server unit 2a, the computing device 20 with the identification code 1002 and the BMC 21 with the identification code 2001 are on the same server unit 2b, and the computing device 20 with the identification code 1003 and the BMC 21 with the identification code 2003 are on the same server unit 2c.

With the above-described technical solutions, the method and system for managing a plurality of server units enable the control unit 1 to recognize a BMC 21 and a computing device 20 being on the same server 2a, 2b or 2c. In this way, the method and system for managing a plurality of server units of the present invention can enhance the collaboration between the BMC and the computing device.

Specifically, a remote management module, such as the control unit 1 in the present embodiment can integrate the monitor information sent from the BMCs 21 more efficiently. Additionally, when one of the computing devices 20 fails to operate, whether due to BIOS failure or operating system failure, the control unit 1 can refer to Table 1 and determine which BMC 21 is on the same server unit as the computing device 20 that is failing. The control unit 1 can subsequently demand said BMC 21 to take corresponding corrective actions, e.g. rebooting. On the contrary, when one of the BMCs 21 needs an update, the control unit 1 can refer to Table 1 and determine which computing device 20 is on the same server unit as the BMC 21 that needs updating. Afterwards, the control unit 1 can send commands to said computing device 20 to perform the update.

The descriptions illustrated supra set forth simply the embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A method for managing a plurality of server units, each server unit having a computing device and a baseboard management controller (BMC) connected thereto, wherein a control unit interfaces with each of the computing devices through a first protocol, and interfaces with each of the BMCs through a second protocol different from the first protocol, and wherein the BMC and the computing device that are on the same server unit each have a server information corresponding to each other, the method comprising:
(a) sending a command through the second protocol via the control unit to each BMC to obtain the server information thereof;
(b) determining, using the control unit, whether the server information of each computing device stored in the control unit corresponds to the server information obtained from one of the BMCs; and
(c) mapping one of the computing devices to one of the BMCs when the server information of said computing device corresponds to the server information obtained from said BMC.

2. The method according to claim 1, wherein the server information of the computing device and the BMC belonging to the same server unit is a MAC address of said server unit.

3. The method according to claim 1, wherein in each server unit, the BMC is disposed on a baseboard of the computing device, and wherein the server information of the computing device and the BMC is a serial number of the baseboard.

4. The method according to claim 1, wherein in each server unit, the server information of the computing device and the BMC is a UUID of the computing device.

5. The method according to claim 1, wherein before step (a), the method further includes:
sending a command through the first protocol via the control unit to each computing device to collect data therefrom, wherein said data includes the server information of the computing device.

6. The method according to claim 1, wherein before step (a), the method further includes:
in each server unit, storing the server information of the computing device in the BMC.

7. The method according to claim 1, wherein step (c) further includes:
building and storing a table in the control unit, wherein in the table, an identification code of said computing device is associated with that of said BMC.

8. A system for managing a plurality of server units, comprising:
a plurality of server units, each of which includes a computing device and a baseboard management controller (BMC) connected thereto, wherein the BMC and the computing device that are on the same server unit each have a server information corresponding to each other; and
a control unit interfacing with each of the computing devices through a first protocol and interfacing with each of the BMCs through a second protocol different from the first protocol, wherein the control unit is configured to send a command through the second protocol to each BMC to obtain the server information thereof, determine whether the server information of each computing device stored in the control unit corresponds to the server information obtained from one of the BMCs, and map one of the computing devices to one of the BMCs when the server information of said computing device corresponds to that of said BMC.

9. The system according to claim 8, wherein the server information of the computing device and the BMC belonging to the same server unit is a MAC address of said server unit.

10. The system according to claim 8, wherein in each server unit, the BMC is disposed on a baseboard of the computing device, and wherein the server information of the computing device and the BMC is a serial number of the baseboard.

11. The system according to claim 8, wherein in each server unit, the server information of the computing device and the BMC is a UUID of the computing device.

12. The system according to claim 8, wherein the control unit is further configured to send a command through the first protocol to each computing device to collect data therefrom before sending the command through the second protocol to each BMC to obtain the server information of the BMC, wherein said data includes the server information of the computing device.

13. The system according to claim 8, wherein for each server unit, the control unit is further configured to store the server information of the computing device in the BMC before sending the command through the second protocol to each BMC to obtain the server information of the BMC.

14. The system according to claim 8, wherein the control unit is further configured to build and store a table therein, wherein in the table, an identification code of said computing device is associated with that of said BMC.
